(19) United States
(12) Patent Application Publication
(10) Pub. No.: US 2012/0038943 A1
(43) Pub. Date: Feb. 16, 2012

(54) DOCUMENT READING APPARATUS, DOCUMENT SIZE DETERMINING METHOD AND IMAGE FORMING APPARATUS

(75) Inventor: Susumu HAKAMADA, Kanagawa (JP)

(73) Assignees: Toshiba Tec Kabushiki Kaisha, Tokyo (JP); Kabushiki Kaisha Toshiba, Tokyo (JP)

(21) Appl. No.: 13/205,407

(22) Filed: Aug. 8, 2011

Related U.S. Application Data
(60) Provisional application No. 61/372,438, filed on Aug. 10, 2010.

(51) Int. Cl. G06K 15/02; G06K 9/00

(52) U.S. Cl. 358/1.13; 382/103

(57) ABSTRACT

According to one embodiment, a document reading apparatus includes plural sensors that are arranged to face a document table and detect a document placed on the document table, a sensor drive unit to power on a first sensor among the plural sensors and to power on a next sensor in a previously set sequence according to a detection result of the first sensor, a size determination unit to determine a size of the document based on a detection result of the document obtained by the powered-on sensor, and a control unit that, when the size of the document can be determined before all of the plural sensors are powered on, stops power supply to a remaining sensor.

### CROSS-REFERENCE TO RELATED APPLICATION

This application is based upon and claims the priority of U.S. Provisional Application No. 61/372,438, filed on Aug. 10, 2010, the entire contents of which are incorporated herein by reference.

### FIELD

Embodiments described herein relate generally to a document reading apparatus to read a document, a document size determining method to determine a document size, and an image forming apparatus including the document reading apparatus.

### BACKGROUND

Hitherto, an image forming apparatus such as an MFP includes a scanner unit and a printer unit. The scanner unit reads a document, the image data read by the scanner unit is processed, and the printer unit prints. Besides, the image forming apparatus includes an auto document feeder (ADF), and the scanner unit reads a document fed by the ADF or reads a document placed on a document table.

In a document reading apparatus of related art, in order to determine the size of a document placed on the document table, plural sensors are arranged below the document table. In order to detect plural documents different in size, such as A3 or A4, all of the plural sensors are in a turned-on state at the time of use of the image forming apparatus.

However, when all the sensors are turned on to determine the size of the document, there is a defect that power consumption increases, and an improvement for achieving power saving is required.

### BRIEF DESCRIPTION OF THE DRAWINGS

FIG. 1 is a structural view showing an image forming apparatus including a document reading apparatus of an embodiment.

FIG. 2 is a plan view showing the arrangement of sensors to detect A-series and B-series documents in the embodiment.

FIG. 3 is a view showing a determination matrix of A-series and B-series document sizes in the embodiment.

FIG. 4 is a flowchart showing the operation of a determination process of A-series and B-series document sizes in the embodiment.

FIG. 5 is a block diagram showing a control system of the image forming apparatus in the embodiment.

FIG. 6 is a plan view showing the arrangement of sensors to detect LT-series documents.

FIG. 7 is a view showing a determination matrix of LT-series document sizes.

FIG. 8 is a flowchart showing the operation of a determination process of LT-series document sizes.

### DETAILED DESCRIPTION

In general, according to one embodiment, a document reading apparatus includes plural sensors that are arranged to face a document table and detect a document placed on the document table, a sensor drive unit to power on a first sensor among the plural sensors and to power on a next sensor in a previously set sequence according to a detection result of the first sensor, a size determination unit to determine a size of the document based on a detection result of the document obtained by the powered-on sensor, and a control unit that, when the size determination unit determines the size of the document before all of the plural sensors are powered on, stops power supply to a remaining sensor.

Hereinafter, an image forming apparatus including a document reading apparatus of an embodiment will be described with reference to the drawings. Incidentally, the same part in the respective drawings is denoted by the same reference numeral.

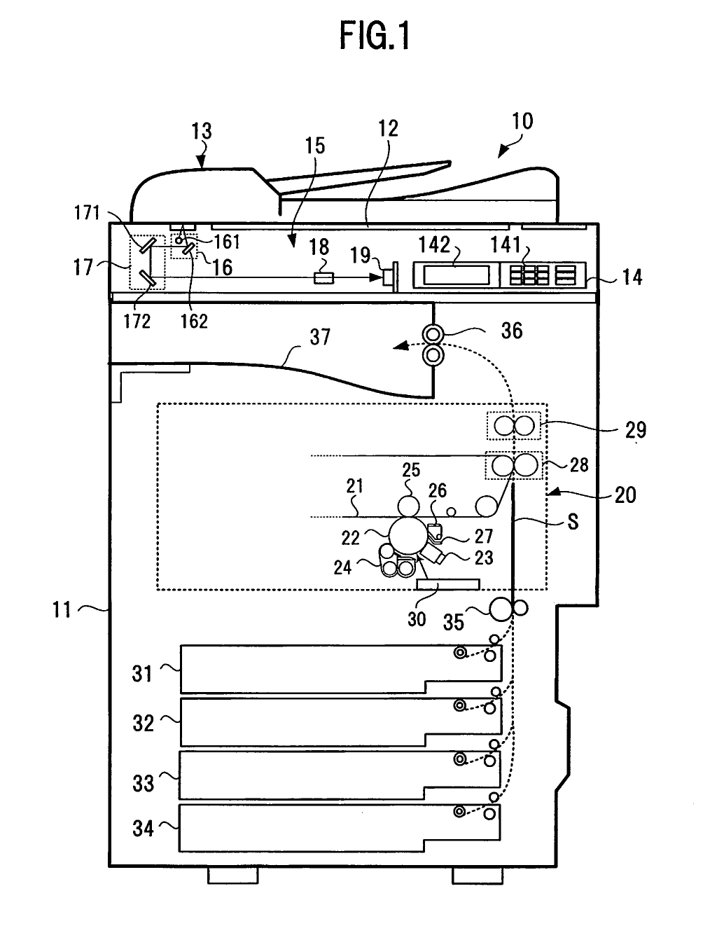

FIG. 1 is a structural view showing the image forming apparatus. The image forming apparatus 10 is, for example, a MFP (Multi-Function Peripherals) as a compound machine, a printer, a copying machine or the like. The following description is made while the MFP is used as an example of the image forming apparatus 10.

A transparent document table 12 is provided at an upper part of a main body 11 of the MFP 10, and an auto document feeder (ADF) 13 is openably and closably provided over the document table 12. Besides, an operation panel 14 is provided at an upper part of the main body 11. The operation panel 14 includes various operation keys 141 and a touch panel display unit 142.

A scanner unit 15 is provided below the document table 12 of the MFP 10. The scanner unit 15 reads an image of a document fed by the ADF 13 or a document placed on the document table 12. The scanner unit 15 includes a first carriage 16 and a second carriage 17.

The first carriage 16 includes a light source 161 to expose and scan a document, and light from the light source 161 is irradiated to the document. The light reflected by the document is reflected by a reflecting mirror 162. The second carriage 17 includes mirrors 171 and 172 to reflect the light reflected by the reflecting mirror 162, and the light reflected by the mirror 172 is guided to a CCD 19 through a lens 18. The CCD 19 is an image sensor. The reflected light from the document is photoelectrically converted by the CCD 19, and an electric signal from the CCD 19 is subjected to image processing, so that image data is generated.

Incidentally, when the scanner unit 15 reads the document fed by the ADF 13, the position of the first carriage 16 is fixed to an illustrated position (below the ADF 13), and the second carriage 17 is located at a position close to the first carriage 16. When the scanner 15 reads the document placed on the document table 12, the first carriage 16 and the second carriage 17 are moved in parallel to the document table 12, and the scanner unit 15 reads the document placed on the document table 12.

A printer unit 20 is provided inside the main body 11. The printer unit 20 includes a photoconductive drum, a laser and the like, processes the image data read by the scanner unit 15 or image data generated by a PC (Personal Computer) or the like, and forms an image on a recording medium. Incidentally, in the following, the description is made while a sheet S is used as an example of the recording medium.

The printer unit 20 includes, for example, plural image forming units below a transfer belt 21 along the upstream side to the down stream side. The image forming unit scans and exposes the surface of a photoconductive drum 22 with a laser beam from the laser 30, and forms an electrostatic latent image on the photoconductive drum 22. A charging charger 23, a developing unit 24, a primary transfer roller 25, a cleaner 26, a blade 27 and the like are arranged around the photoconductive drum 22.

The charging charger 23 uniformly charges the whole surface of the photoconductive drum 22. The developing unit 24 includes a mixer to agitate a developer and a developing roller to which a development bias is applied, and supplies the toner of two-component developer including toner and carrier to the photoconductive drum 22 by the developing roller. The cleaner 26 uses the blade 27 and removes the remaining toner on the surface of the photoconductive drum 22.

A toner image on the photoconductive drum 22 is transferred to the transfer belt 21 by the primary transfer roller 25, and the toner image transferred to the transfer belt 21 is transferred to the sheet S by a secondary transfer roller 28. The toner image transferred to the sheet S is fixed by a fixing unit 29. The fixing unit 29 includes a fixing roller and a pressure roller, and the sheet S passes through between the fixing roller and the pressure roller, so that the toner image on the sheet S is fixed to the sheet S.

When a color image is formed, the printer unit 20 includes plural image forming units of black, magenta, cyan, yellow and the like. Incidentally, the structure of the printer unit 20 is not limited to the above example, and there are various systems.

Plural cassettes 31 to 34 to contain sheets of various sizes are provided at a lower part of the main body 11. Incidentally, the number of the cassettes is not limited to four. A conveyance roller 35 to convey the sheet S taken out from each of the cassettes 31 to 34 to the printer unit 20 is provided between the secondary transfer unit 28 and the cassettes 31 to 34. The sheet S on which the toner image is fixed by the fixing unit 29 and the image formation is completed is discharged to a paper discharge part 37 by a paper discharge roller 36.

In the document reading apparatus, in order to detect the size of a document placed on the document table 12, plural sensors are arranged below the document table 12, and the size of the document is determined based on the detection results of the respective sensors. In the related art, since all of the plural sensors are operated to determine the document size, the power consumption increases.

In the document reading apparatus of the embodiment, the plural sensors to detect a document are powered on in a previously set sequence, and the size of the document is determined based on the detection result of each sensor, so that the power saving is achieved.

Hereinafter, the arrangement of plural sensors to detect a document will be described.

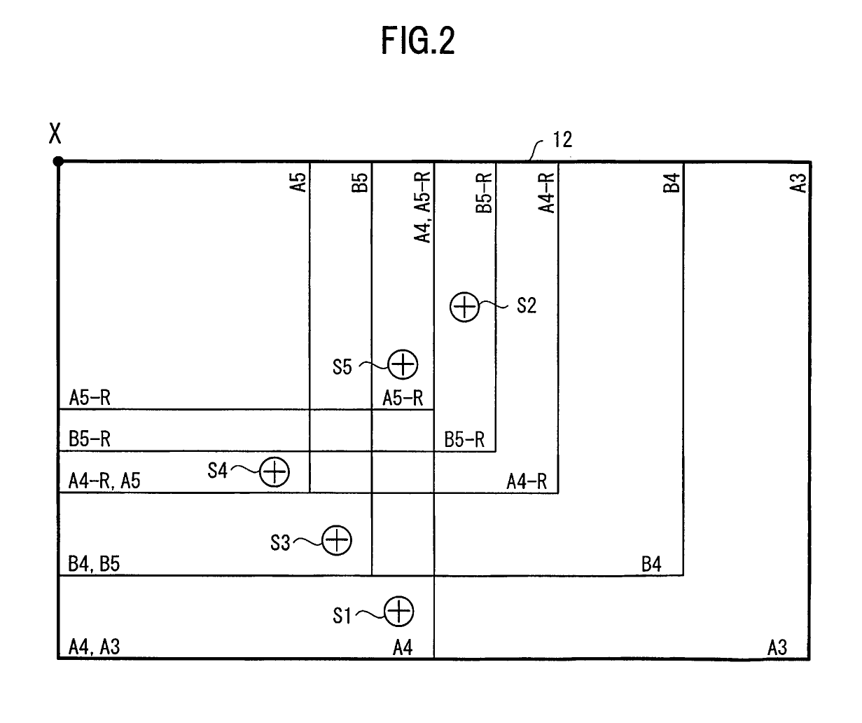

FIG. 2 is a plan view showing the arrangement of sensors S1 to S5 used for determining the sizes of eight kinds of A-series and B-series documents (A3, A4, A5, B4, B5, A4-R, B5-R, A5-R), and shows positions of the sensors S1 to S5 when the document table 12 is seen from right above. Each of the sensors S1 to S5 includes a light-emitting element and a light-receiving element. The light-emitting element irradiates light to a document, and the light-receiving element receives the light reflected by the document, so that the presence or absence of the document is detected.

When a corner point as a positioning reference when a document is placed on the document table 12 is X, the sensor S1 is located at a position farthest from the corner point X, and the sensor 2 is located at a position next farthest from the corner point X. The sensor S4 and S5 are located at positions close to the corner point X.

That is, the sensor S1 is located at the lower right end of an A4 document, the sensor S2 is located at the right end center of a B5-R document, and the sensor S3 is located at the lower right end of a B5 document. The sensor S4 is located the lower right end of an A5 document, and the sensor S5 is located at the lower right end of an A5-R document.

The sensor S1 detects the presence or absence of the A4 and A3 documents, and the sensor S2 detects the presence or absence of the B5-R document. The sensor S3 detects the presence or absence of the B4 and B5 documents, and the sensor S4 detects the presence or absence of the A4-R and A5 documents. The sensor S5 detects the presence or absence of the A5-R document.

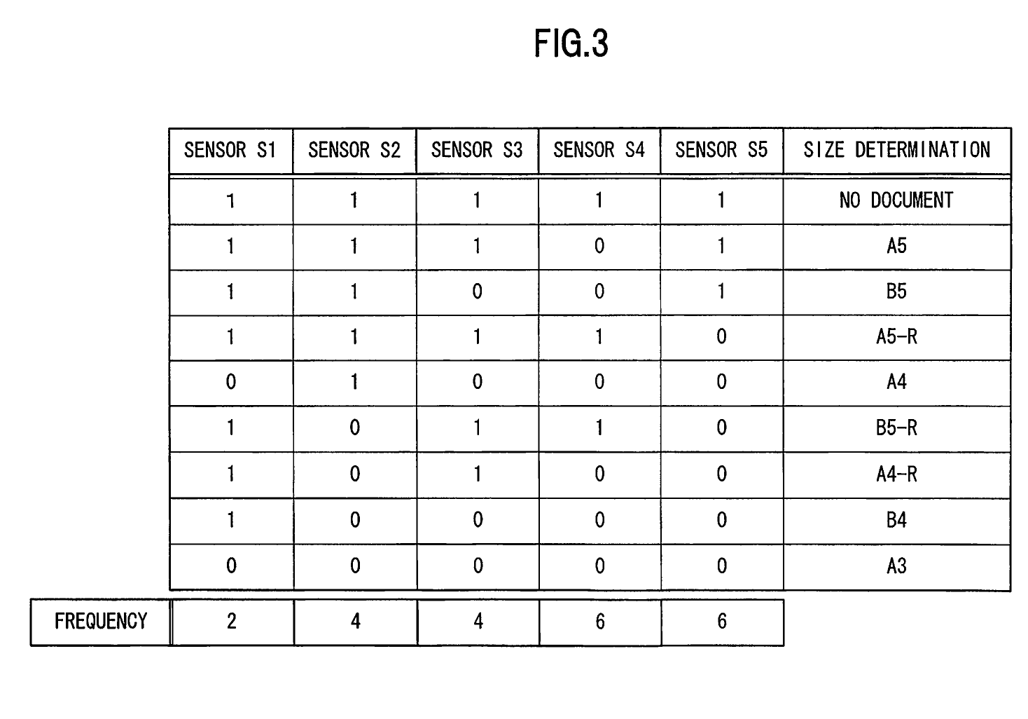

FIG. 3 is a view showing a logical matrix of document size determination based on the detection results of the respective sensors S1 to S5. In FIG. 3, a state where a sensor is on and there is a document is “0”, and a state where a sensor is off and there is no document is “1”. For example, when all the sensors S1 to S5 are determination is made that there is no document, and when all the sensors S1 to S5 are “0”, the document size is determined to be A3.

In FIG. 3, with respect to the A-series and B-series document sizes, the five sensors S1 to S4 detect nine kinds of document sizes including the state where there is no document. In some sensors, the number of times where “0” occurs is small. The lower part of FIG. 3 shows a frequency when the sensors S1 to S5 become “0”. The frequency of the sensor S1 is 2, the frequencies of the sensors S2 and S3 are 4, and the frequencies of the sensors S5 and S6 are 6.

In the embodiment, from FIG. 3, attention is paid to the fact that the frequency of the sensor S1 is lowest, and when the document size is determined, the sensor S1 is first powered on. With respect to the other sensors, determination is made based on the state of the sensor S1 as to whether or not the other sensors are powered on.

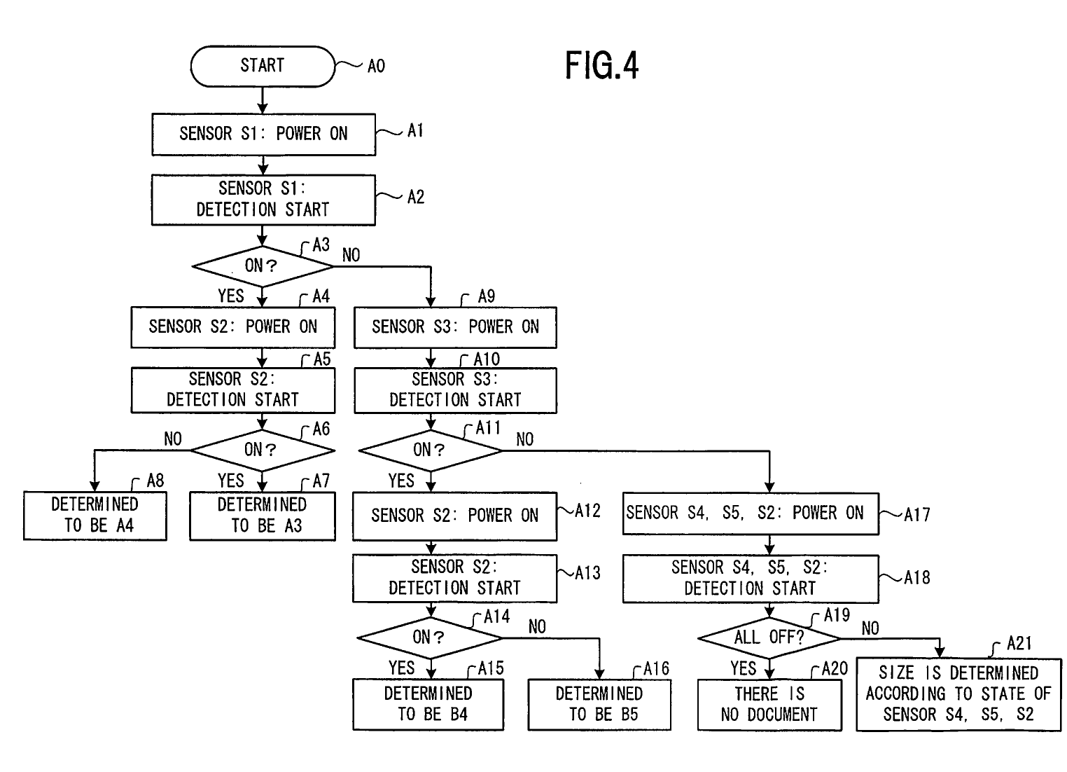

Hereinafter, timings when the sensors S1 to S5 are powered on and the operation of the determination process of the document size will be described along the flowchart of FIG. 4.

In FIG. 4, at Act A0, determination of a document size starts, and at Act A1, the sensor S1 is powered on. At Act A2, the sensor S1 starts to detect the presence or absence of a document. At Act A3, determination is made as to whether or not the sensor S1 is on. When the sensor S1 is on and is “0”, at Act A4, the sensor S2 is powered on, and at Act A5, the sensor S2 starts to detect the presence or absence of the document. At Act A6, determination is made as to whether or not the sensor S2 is on. When the sensor S2 is on and is “0”, at Act A7, the document size is determined to be A3. At Act A6, when the sensor S2 is not on and is “1”, at Act A8, the document size is determined to be A4.

That is, since the sensor S1 is on only when the document size is A3 or A4, the state of the sensor S2 is detected, and when the sensor S2 is on, the document size is determined to be A3, and when the sensor S2 is off, the document size is determined to be A4. Accordingly, when the document size is A3 or A4, only the sensor S1 and the sensor S2 are powered on, and the other sensors S3 to S5 are not powered on. Accordingly, the power consumption can be reduced.

At Act A3, when the sensor S1 is off and is “1”, at Act A9, the sensor S3 is powered on, and at Act A10, the sensor S3 starts to detect the presence or absence of a document. At Act A11, determination is made as to whether or not the sensor S3 is on. When the sensor S3 is on and is “0”, at Act A12, the sensor S2 is powered on, and at Act A13, the sensor S2 starts to detect the presence or absence of a document. At Act A14, determination is made as to whether or not the sensor S2 is on. When the sensor S2 is on and is “0”, at Act A15, the document size is determined to be B4. At Act A14, when the sensor S2 is not on and is “1”, at Act A16, the document size is determined to be B5.

That is, since the sensor S1 is off when the document size is other than A3 or A4, the state of the sensor S3 is further detected. When the sensor S3 is on and is “0”, the document size is B4 or B5. Accordingly, the state of the sensor S2 is further detected, and when the sensor S2 is on and is “0”, the document size is determined to be B4, and when the sensor S2 is off, the document size is determined to be B5.

Accordingly, when the document size is A3, A4, B4 or B5, only the sensors S1, S2 and S3 are powered on, and the other sensors S4 and S5 are not powered on.

At Act A11, when the sensor S3 is off and is “1”, at Act A17, the sensors S4, S5 and S2 are powered on, and at Act A18, the sensors S4, S5 and S2 start to detect the presence or absence of a document. At Act A19, determination is made as to whether or not all the sensors S1 to S5 are off. When all the sensors S1 to S5 are off and are “1”, at Act A20, determination is made that there is no document.

At Act A19, when all the sensors A1 to A5 are not off, advance is made to Act A21, and the document size is determined from the on or off states of the sensors S4, S5 and S2.

That is, when the sensors S1 and S3 are off and one of the sensors S4, S5 and S2 is on and is “0”, the document size is one of A5, A5-R, B5-R and A4-R. Accordingly, the document size (A5, A5-R, B5-R, A4-R) is determined in accordance with the logical matrix shown in FIG. 3.

As described above, when the document size is determined, the two sensors of the sensor S1 and the sensor S2 located at the positions far from the corner point X are first powered on, so that at least the document sizes of A4 and A3 can be determined. Since the use frequency of the A3 or A4 size document is high, when determination can be made as to whether the size is A3 or A4, the remaining sensors S3 to S5 are not required to be powered on. Accordingly, power saving at the time of determination of the document size can be achieved.

When the document size is neither A3 nor A4, the sensors S1, S2 and S3 are powered on, so that the B4 and B5 documents having next higher use frequency can be determined. In this way, the sensor far from the corner point X is first powered on, and the document size is determined, and when the size can not be determined, the sensor located at the position close to the corner point X is powered on. Accordingly, the power consumption can be reduced.

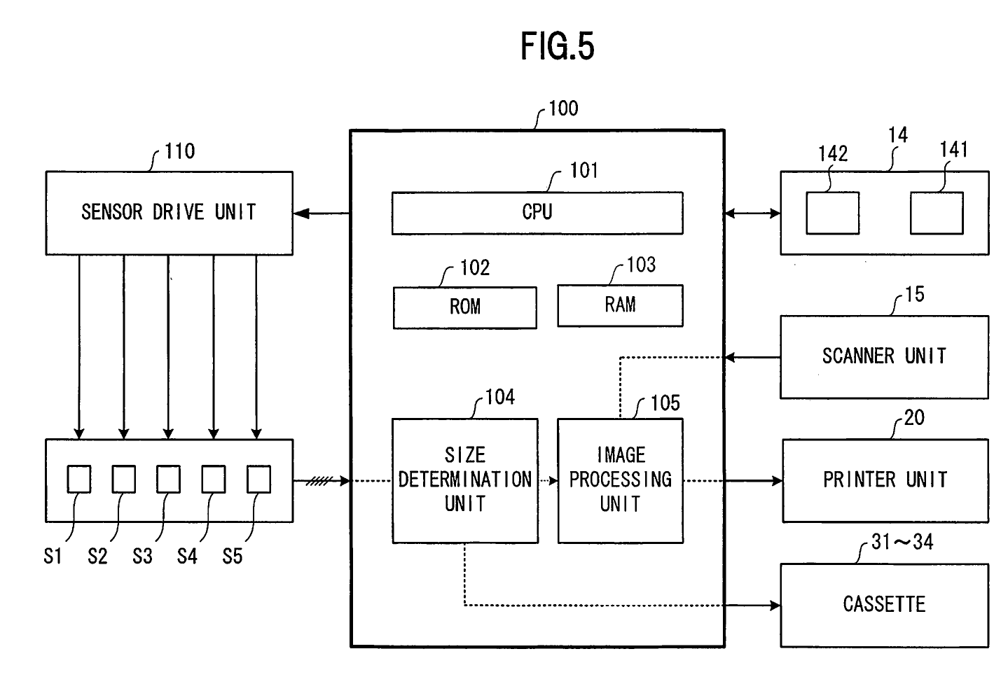

FIG. 5 is a block diagram showing a control system of the image forming apparatus 10. In FIG. 5, a main control unit 100 includes a CPU 101, a ROM 102, a RAM 103, a size determination unit 104 and an image processing unit 105.

The CPU 101 controls the image forming apparatus 10 in accordance with a control program stored in the ROM 102. Besides, the main control unit 100 controls the operation of the scanner unit 15 and the printer unit 20 in response to the user's operation of the operation panel 14. The RAM 103 is used for temporarily storing control data, or is used for arithmetic operation at the time of control.

The size determination unit 104 determines the size of a document based on the detection results of the sensors S1 to S5. The image processing unit 105 performs a process, such as magnification conversion, on the image data read by the scanner unit 15. When the determined document size is different from the sheet size to be used, the image processing unit 105 can set to change the magnification of the image data to be printed and to perform an image processing.

The operation panel 14 includes the plural keys 141 and the display unit 142 used also as the touch panel, and gives various instructions for image formation. For example, the instruction for the number of copies is given by using the keys 141, and the instruction for the sheet size or magnification is given by operating the touch panel of the display unit 142. The execution of the copy or the like is started by the operation of a start key.

Besides, the main control unit 100 is connected to a sensor drive unit 110. The sensor drive unit 110 controls power supply to the sensors S1 to S5 under the control of the CPU 101. The sensors S1 to S5 are powered on in the sequence shown in the flowchart of FIG. 4. The detection results (0, 1) of the sensors S1 to S5 are sent to the main control unit 100, and the size determination unit 104 determines the size of the document according to the detection results of the sensors S1 to S5 and in accordance with the flowchart of FIG. 4.

The main control unit 100 controls the sensor drive unit 110, and when the size determination unit 104 can determine the document size before all the sensors S1 to S5 are powered on, the remaining non-power-on sensors are not powered on.

Besides, from the determination result of the size determination unit 104, the main control unit 100 controls so that a sheet having the same size as the document size is taken out one by one from the corresponding cassette among sheets contained in the cassettes 31 to 34, and is conveyed to the printer unit 20. Alternatively, a sheet having the size specified by the user is taken out one by one from the corresponding cassette, and is conveyed to the printer unit 20. Accordingly, the main control unit 100 functions also as a selection unit to select the cassette according to the document size.

For example, when the user sets a document on the document table 12 and performs a copy operation without specifying the sheet size, the size determination unit 104 of the main control unit 100 determines the document size based on the results detected by the sensors S1 to S5. Then, the cassette (31 to 34) containing sheets having the same size as the document size is selected, and the sheet S is taken out one by one from the corresponding cassette, and is conveyed to the printer unit 20. The image processing unit 105 outputs the image data of the document read by the scanner unit 15 while the size is made the same as the sheet size, and the printer unit forms an image on the sheet S.

When the user sets a document on the document table 12, and specifies the sheet size (for example, when the document size is A3 and the specified sheet size is A4), a sheet having the specified size is taken out from the cassette (31 to 34) and is conveyed to the printer unit 20. The size determination unit 104 determines the document size based on the results detected by the sensors S1 to S5. When the document size is different from the specified sheet size, the image processing unit 105 changes the magnification of the image data read by the scanner unit 15 and prints the data on the sheet S. For example, when the document size is A3 and the size of the sheet S specified by the user is A4, the data is reduced and is printed. Of course, when the user specifies the sheet or the copy magnification, printing is performed on the specified sheet and with the specified magnification.

As a result of the determination of the document size by the size determination unit 104, when the sheet having the corresponding size is not contained in the cassettes 31 to 34, the main control unit 100 displays, on the display unit 142 of the operation panel 14, the warning that there is no sheet having the same size as the document.

Although FIG. 1 shows the image forming apparatus 10 including the four cassette 31 to 34, actually, as shown in FIG. 3, there are eight kinds of document sizes. Thus, sheets corresponding to all documents can not be contained in the cassettes 31 to 34. Accordingly, when the sheet having the same size as the document is not contained in the cassettes 31 to 34, the warning is displayed.

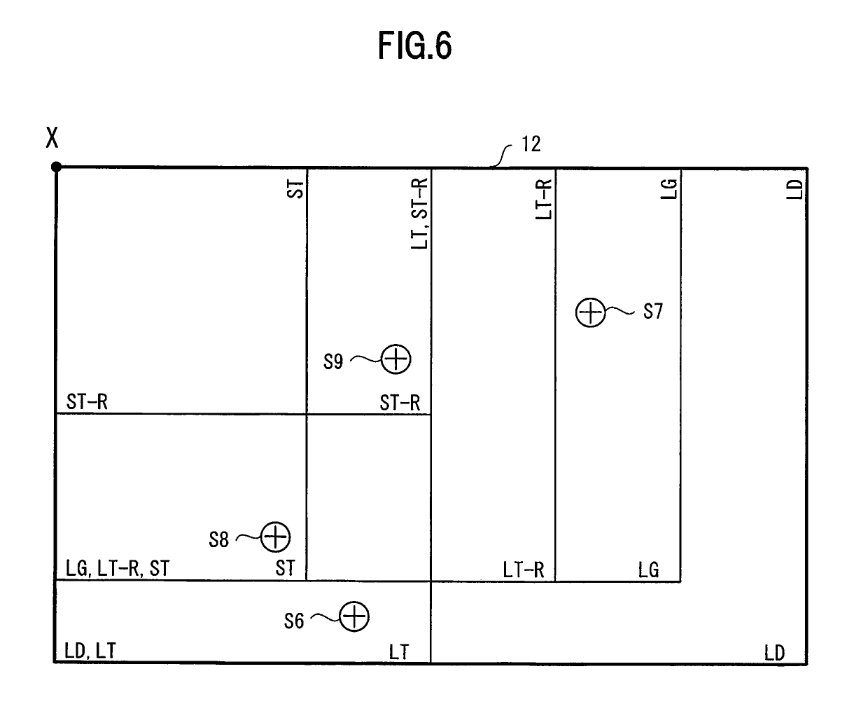

FIG. 6 is a plan view showing the arrangement of sensors S6 to S9 to detect six kinds of LT-series documents (LD, LT, LG, ST, LT-R, ST-R). A sensor S6 is located at the lower right end of an LT document, a sensor S7 is located at the right end center of an LG document, and a sensor S8 is located at the lower right end of an ST document. Besides, the sensor S9 is located at the lower right end of an ST-R document.

The sensor S6 detects the presence or absence of the LD and LT documents, and the sensor S7 detects the presence or absence of the LG document. The sensor S8 detects the presence or absence of the LT-R and the ST documents, and the sensor S9 detects the presence or absence of the ST-R document.

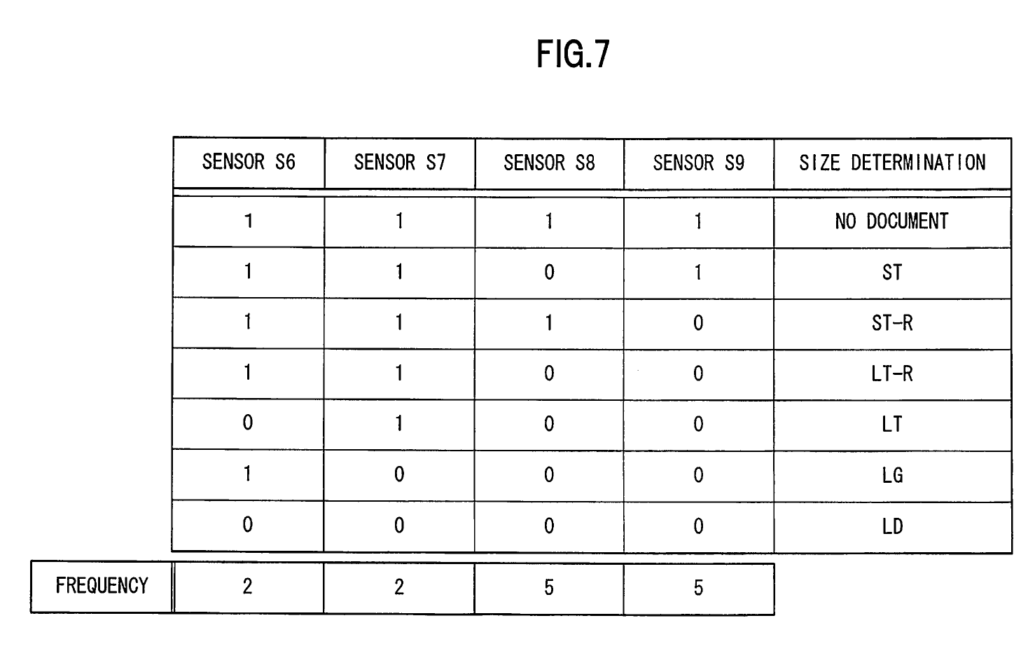

FIG. 7 is a view showing a determination matrix of document size based on the detection results of the respective sensors S6 to S9. In FIG. 7, for example, when all the sensors S6 to S9 are “1”, determination is made that there is no document, and when all the sensors S6 to S9 are “0”, the document size is determined to be LD.

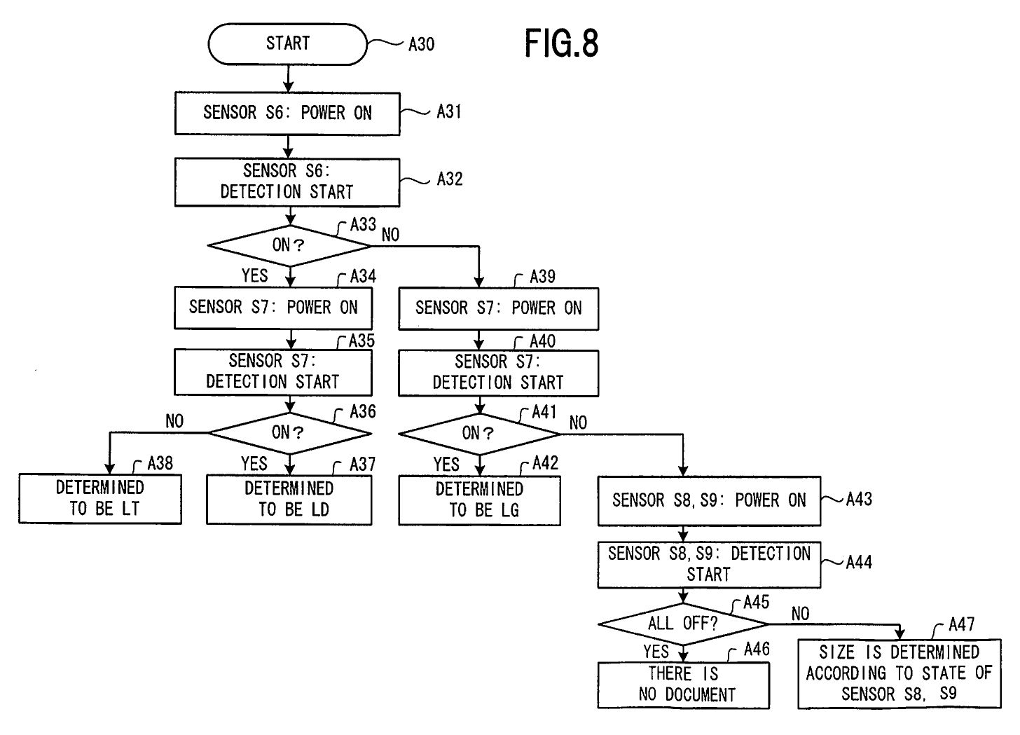

Hereinafter, timings when the sensors S6 to S9 are powered on and the operation of the determination process of the document size will be described along the flowchart of FIG. 8.

In FIG. 8, at Act A30, determination of the document size starts, and at Act A31, the sensor S6 is powered on. At Act A32, the sensor S6 starts to detect the presence or absence of the document. At Act A33, determination is made as to whether or not the sensor S6 is on. When the sensor S6 is on and is “0”, at Act A34, the sensor S7 is powered on, and at Act A35, the sensor S7 starts to detect the presence or absence of a document. At Act A36, determination is made as to whether or not the sensor S7 is on. When the sensor S7 is on and is “0”, at Act A37, the document size is determined to be LD. At Act A36, when the sensor S7 is not on and is “1”, at Act A38, the document size is determined to be LT.

That is, since the sensor S6 is on only when the document size is LD or LT, the state of the sensor S7 is detected, and when the sensor S7 is on and is “0”, the document size is determined to be LD, and when the sensor S7 is off, the document size is determined to be LT. Accordingly, when the document size is LD or LT, only the sensor S6 and the sensor S7 are powered on, and the other sensors S8 and S9 are not powered on. Accordingly, power consumption can be reduced.

Besides, at Act A33, when the sensor S6 is off and is “1”, at Act A39, the sensor S7 is powered on, and at Act A40, the sensor S7 starts to detect the presence or absence of a document. At Act A41, determination is made as to whether or not the sensor S7 is on. When the sensor S7 is on and is “0”, the document size is determined to be LG.

That is, since the sensor S6 is off when the document size is other than LD or LT, the state of the sensor S7 is further detected. When the sensor S7 is on and is “0”, the document size is determined to be LG. Accordingly, when the document size is LD, LT or LG, only the sensors S6 and S7 are powered on, and the other sensors S8 and S9 are not powered on.

Besides, at Act A41, when the sensor S7 is off and is “1”, at Act A43, the sensors S8 and S9 are powered on, and at Act A44, the sensors S8 and S9 start to detect the presence or absence of a document. At Act A45, determination is made as to whether or not all the sensors S6 to S9 are off. When all the sensors S6 to S9 are off and are “1”, at Act A46, determination is made that there is no document.

At Act A46, when all the sensors S6 to S9 are not off, advance is made to Act A47, and the document size is determined from the on or off states of the sensors S8 and S9. That is, when the sensor S6 and S7 are off, and one of the sensors S8 and S9 is on and is “0”, the document size is one of LT-R, ST-R and ST. Thus, the document size (LT-R, ST-R and ST) is determined in accordance with the logical matrix shown in FIG. 7.

As stated above, when the LT-series document sizes are determined, the two sensors of the sensor S6 and the sensor S7 located at the positions far from the corner point X are first powered on, so that at least the document sizes of LD, LT and LG can be determined. Since the use frequency of the document of LD, LT or LG size is high, when the size of LD, LT or LG can be first determined, power saving at the time of determination of the document size can be achieved. When the document size is not LD, LT or LG, the sensors S8 and S9 arranged at the positions close to the corner point X are powered on, so that the other document size can be determined.

Incidentally, when the LT-series document sizes are detected, in the block diagram shown in FIG. 5, the sensors S1 to S5 have only to be replaced by the sensors S6 to S9. The size determination unit 104 determines the document size in accordance with the flowchart of FIG. 7.

According to the embodiment described above, when the document size is determined, the plural sensors are powered on in the previously set sequence, so that the power consumption is reduced and the determination can be made.

While certain embodiments have been described, these embodiments have been presented by way of example only, and are not intended to limit the scope of the invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. A document reading apparatus comprising:
a plurality of sensors that are arranged to face a document table and detect a document placed on the document table;
a sensor drive unit to power on a first sensor among the plurality of sensors and to power on a next sensor in a previously set sequence according to a detection result of the first sensor;
a size determination unit to determine a size of the document based on a detection result of the document obtained by the powered-on sensor; and
a control unit that, when the size determination unit determines the size of the document before all of the plurality of sensors are powered on, stops power supply to a remaining sensor.

2. The apparatus of claim 1, wherein the first sensor detects a document of a size having a high use frequency.

3. The apparatus of claim 1, wherein the sensor drive unit preferentially powers on a sensor arranged at a position far from a corner point as a reference when the document is placed on the document table.

4. The apparatus of claim 1, wherein when the size of the document cannot be determined even when the sensor drive unit powers on a sensor arranged at a position far from a corner point as a reference when the document is placed on the document table, the sensor drive unit powers on a sensor arranged at a position close to the corner point.

5. The apparatus of claim 1, wherein the plurality of sensors outputs detection results that there is a document when the sensors are in an on state and there is no document when the sensors are in an off state, and the size determination unit determines the size of the document by an on and off logical matrix of the plurality of sensors.

6. The apparatus of claim 3, further comprising:
a reading unit to read the document placed on the document table; and
an image processing unit to process image data of the document read by the reading unit, wherein
the image processing unit changes a magnification of the image data in accordance with the document size determined by the size determination unit.

7. A document size determining method comprising:
arranging a plurality of sensors to face a document table and to detect a document placed on the document table;
powering on a first sensor among the plurality of sensors and powering on a next sensor in a previously set sequence according to a detection result of the first sensor;
determining a size of the document based on a detection result of the document obtained by the powered-on sensor; and
stopping, when the size of the document is determined before all of the plurality of sensors are powered on, power supply to a remaining sensor.

8. The method of claim 7, wherein the first sensor detects a document of a size having a high use frequency.

9. The method of claim 7, wherein a sensor arranged at a position far from a corner point as a reference when the document is placed on the document table is preferentially powered on.

10. The method of claim 7, wherein when the size of the document can not be determined even when a sensor arranged at a position far from a corner point as a reference when the document is placed on the document table is powered on, a sensor arranged at a position close to the corner point is powered on.

11. The method of claim 7, wherein the plurality of sensors output detection results that there is a document when the sensors are in an on state and there is no document when the sensors are in an off state, and the size of the document is determined by an on and off logical matrix of the plurality of sensors.

12. The method of claim 7, further comprising:
reading the document placed on the document table by a reading unit;
processing image data of the document read by the reading unit; and
changing a magnification of the image data in accordance with the document size determined by the size determination unit.

13. An image forming apparatus comprising:
a reading unit to read a document placed on a document table and to generate image data;
a printer unit to form an image on a recording medium based on the image data;
a plurality of sensors that are arranged to face the document table and detect the document placed on the document table;
a sensor drive unit to power on a first sensor among the plurality of sensors and to power on a next sensor in a previously set sequence according to a detection result of the first sensor;
a size determination unit to determine a size of the document based on a detection result of the document obtained by the powered-on sensor;
a control unit that, when the size determination unit determines the size of the document before all of the plurality of sensors are powered on, stops power supply to a remaining sensor; and
a selection unit to select the recording medium to be supplied to the printer unit based on a determination result of the size determination unit.

14. The apparatus of claim 13, wherein the first sensor detects a document of a size having a high use frequency.

15. The apparatus of claim 13, wherein the sensor drive unit preferentially powers on a sensor arranged at a position far from a corner point as a reference when the document is placed on the document table.

16. The apparatus of claim 13, wherein when the size of the document cannot be determined even when the sensor drive unit powers on a sensor arranged at a position far from a corner point as a reference when the document is placed on the document table, the sensor drive unit powers on a sensor arranged at a position close to the corner point.

17. The apparatus of claim 13, further comprising
a plurality of cassettes to contain a plurality of recording media difference in size, wherein
the selection unit takes out a recording medium from a cassette in which recording media corresponding to the document size determined by the size determination unit are contained, and supplies the recording medium to the printer unit.

18. The apparatus of claim 17, further comprising
a display unit to display a warning when a recording medium corresponding to the document size determined by the size determination unit is not contained in the cassettes.

19. The apparatus of claim 13, further comprising:
an operation panel that can be operated by a user; and
an image processing unit to process the image data generated by the reading unit, wherein
when the document size determined by the size determination unit is different from a size of the recording medium specified by a user, the image processing unit changes a magnification of the image data in accordance with the size of the recording medium.

20. The apparatus of claim 19, wherein when the user specifies a magnification, the image processing unit processes the image data with the specified magnification.
